(19) United States
(12) Patent Application Publication
(10) Pub. No.: US 2008/0244999 A1
(43) Pub. Date: Oct. 9, 2008

(54) Frame, in Particular for Window, Door or Facade Elements

(76) Inventor: Josef Westermann, Steinfeld (DE)

Correspondence Address: GUDRUN E. HUCKETT DRAUDT, SCHUBERTSTR. 15A, WUPPERTAL, 42289, DE

(21) Appl. No.: 11/576,757

(22) PCT Filed: Oct. 6, 2005
(86) PCT No.: PCT/EP05/10769

§ 371 Date: Feb. 5, 2008

(30) Foreign Application Priority Data
Oct. 9, 2004 (DE) 10 2004 049 335.9

(51) Int. Cl. E06B 7/10

(52) U.S. Cl. 52/204.1

(57) ABSTRACT

The invention concerns a frame for use in wall openings of rooms, in particular for doors, windows or other facade elements, comprising a profiled frame section 3 which comprises at least one basic profiled frame section 4 and has a cavity 7 that is connectable for venting with the interior and/or exterior side 13, 14 of the room, wherein the cavity 7 has a venting element 6 movably arranged therein and embodying at least one air passage, whose main axis 9 extends parallel to the longitudinal extension of the profiled frame section 3 and is part of a venting system.

The invention relates to a frame for use in wall openings of rooms, in particular for window, door or other facade elements, comprising a profiled frame section that comprises at least one basic profiled frame section and a cavity for venting which cavity is connectable by openings to an interior side and an exterior side of the room.

Modern window, door and facade elements close off building openings in such a way that practically no exchange of air between the interior of the room and the exterior of the room, usually outdoors, takes place. In the case of rooms that are closed off in such a way there are often problems as a result of insufficient venting and increased mold build-up; this generally leads to bad room air conditions.

For solving this problem, DE 201 05 296 U1 discloses a venting device for window, door, facade elements or the like that comprises a cavity, arranged in a frame or between a casement frame and a wing frame, that is connectable for venting by means of openings to an interior room and the ambience, wherein the openings can be closed by means of a slide. Accordingly, even for a closed wall opening a regular venting is made possible.

In this connection, it is a disadvantage that the visual appearance of the frame is negatively affected by the slide and, as a result of the openings or cutouts to be provided in the seals, the insulation effect of the frame in the closed state is reduced.

It is therefore an object of the present invention to provide a frame for a door, a window, or a facade element or the like with an improved venting device.

This object is solved by an article of the aforementioned kind that has a venting element movably arranged in a cavity which venting element forms at least one air passage and whose main axis is parallel to the longitudinal extension of the profiled frame section and is furthermore part of a venting system. By arranging a movable part of the venting system in the frame, on the one hand, the visual appearance of the frame according to the invention is improved and, on the other hand, the available interior space of the frame is optimally utilized. By aligning the main axis of the movable venting element parallel to the longitudinal extension of the profiled frame section, there is moreover more space available for the venting element. The movement of the venting element leads to a connection for venting of the interior side to the exterior side by means of an air passage that is formed by the shape of the venting element or to an interruption of this connection by means of an area of the venting element that does not form the air passage. In this basic configuration the venting system is essentially comprised of the venting element.

In an advantageous embodiment of the invention, the venting element is divided into one, preferably two venting element chambers, wherein by movement or positional change of the venting element one of the venting element chambers provides a venting connection between the air supply and air removal areas that are located on at least two sides of the cavity and correlated with the interior and exterior sides of the room. In this connection, the terms air supply area or air removal area is be understood as the areas of the frame outside of the venting element or of the cavity through which areas, depending on the flow direction of the air, the air is supplied to the room or removed therefrom. The venting element chamber forming the air passage is provided with openings through which the air can pass wherein such a venting element chamber can be formed also by a wall of the cavity. The second venting element chamber can be filled, for example, with insulation material in order to ensure proper insulation in the closed position.

As a result of the plurality of possible arrangements of the air supply and air removal areas as well as the possibility of dividing the venting element into one, two or several venting element chambers, thus enabling different connecting possibilities between the individual air supply and air removal areas, the frame according to the invention is suitable for a plurality of different venting conditions.

For example, it is within the scope of the invention to provide an air passage formed by the venting element with a pollen filter so that in pollen season people allergic to pollen can enjoy the advantage of having pollen-free room air. Alternatively, for example, in the case of rain or when the air does not contain pollen, another air passage or venting channel can be selected in order to allow venting of the room without pollen filter.

The frame according to the invention provides the possibility of designing the venting system in a modular way as described in the following.

It is within the scope of the invention to employ in place of the pollen filter any other suitable air filter and to insert it into the air supply or air removal area. These areas are configured in particular by the profiled frame section, i.e., in particular entirely by a casement frame, by a wing frame or by a combination of the two.

According to a further advantageous configuration of the invention it is provided that at least one air supply area or air removal area is separated relative to an interior side and/or exterior side of the room with at least one perforated and/or slotted additional profiled section. This additional profiled section is preferably attachable to the basic profiled frame section or the profiled frame section and serves, on the one hand, for preventing unhindered passage of e.g. small animals through the opened air passage and, on the other hand, for producing a pleasing appearance of the venting openings. In this case it is also possible to provide the additional profiled section or the delimiting profiled section with a filter material in order to remove e.g. pollen from the air.

The venting elements can be configured as a rotatable venting pipe wherein the at least one venting pipe chamber provides a venting connection between the interior and exterior sides of the room that can be interrupted by rotating the venting pipe about its axis.

In an alternative configuration the venting element is configured as a profiled chamber element that is slidable in a direction of its axis.

Advantageously, the venting element, that can be actuated e.g. also manually when the window is open or by means of an actuating element when the window is closed, is adjustable by means of a motor. This motor can then be used with a control unit arranged so as not to be noticeable or by a remote-control unit for adjusting the venting system.

According to a further advantageous embodiment of the invention, the venting system has additionally at least one sensor, even better two or more sensors that detect environmental data outside and/or inside the room. These environmental data include, in addition to temperature and humidity, the wind situation, for example. By means of the sensors, the data are transferred to the control unit or electronic control that controls venting of the room based on the data received from the at least one sensor.

In addition, it is also conceivable to design the entire venting system so as to be programmable or to be adjustable to preferential values so that, for example, during a period of absence an automatic venting of the room is ensured without the window having to be opened. Moreover, venting of the room is possible in any weather condition.

For an optimal insulation of the frame the part of the cavity that is not provided with the venting system can be sealed off by an insulation materials. Also, parts of the venting element that do not form a passage for incoming or outgoing air can be filled with insulation materials in order to ensure optimal insulation of the casement frame.

The parts of the venting system arranged within a frame are provided in the case of a window preferably in the lateral areas. Because of the identical structure of the profiled frame sections in the upper and lower areas of a window, the remaining cavity, i.e., the top and bottom cavities, can be utilized as a multifunctional chamber instead of for insulation purposes, into which chamber, for example, an insect protection device for closing off the window by means of an insect screen or a shade membrane for darkening the room interior can be mounted. The laterally attached attachment profiled section of the frame according to the invention can represent the lateral guide areas of the screen or the membrane while the frame area that is arranged opposite the multifunctional chamber is configured to receive the screen end or membrane end.

When the venting system is closed, a plurality of sealing planes prevent an air flow that would cause energy loss between a wing frame and a casement frame of a window; in particular a central circumferential sealing plane contributes to this.

Advantageously, the cavity containing parts of the venting system is arranged in an area of the casement frame; however, it is also within the scope of the present invention to arrange the cavity together with the appropriate parts of the venting system in a wing frame belonging to a casement frame.

The object is furthermore solved by a door with a frame that has the above described features or the features to be described in the following. Instead of a door, this can also be a window or other facade elements with or without wing frame that are used for closing off building openings.

Further details and advantages of the invention result from the schematic illustrations of different embodiments of the invention described in the following. The Figures show in:

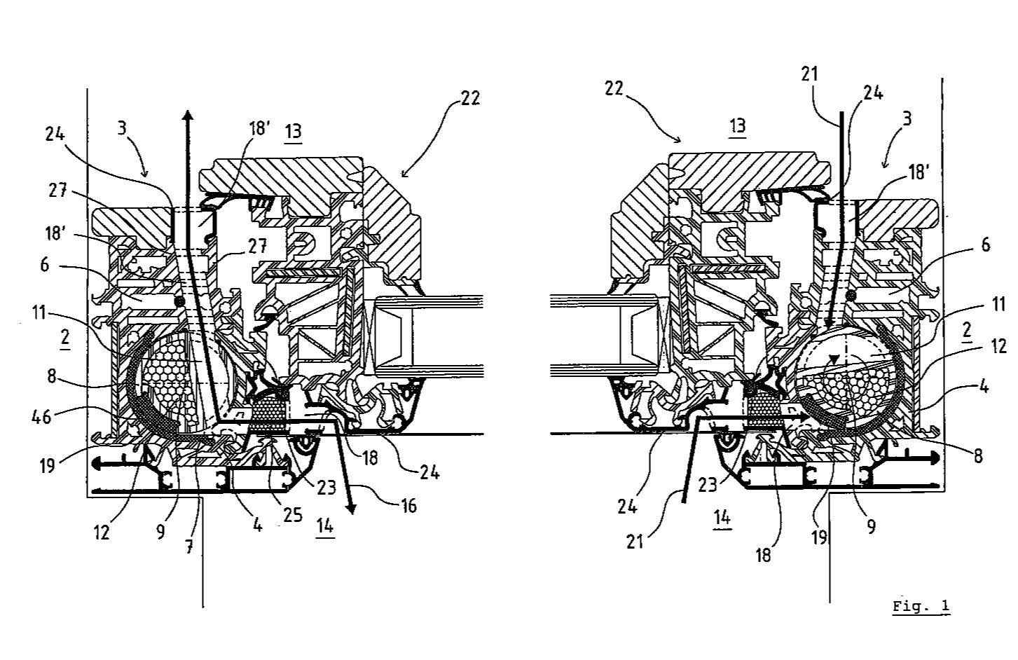

FIG. 1 a casement frame in horizontal section comprising a wing frame wherein the venting system is opened to the left and closed to the right of the Figure;

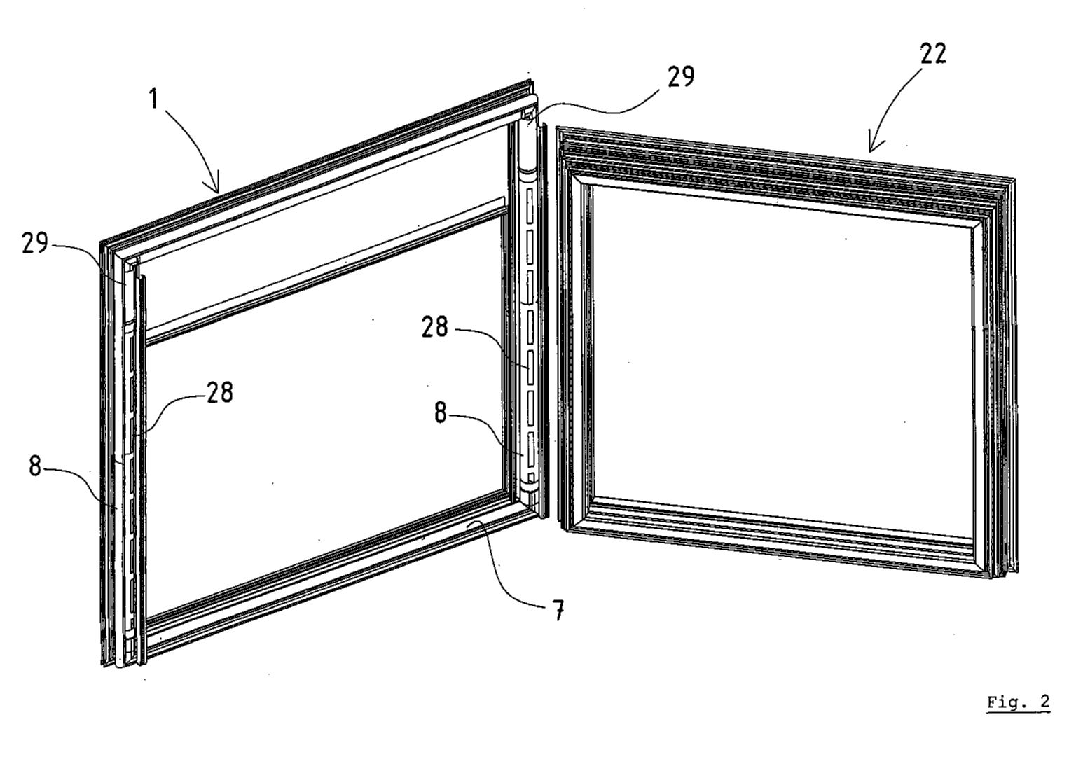

FIG. 2 a complete casement frame according to FIG. 1 in a partially sectioned view;

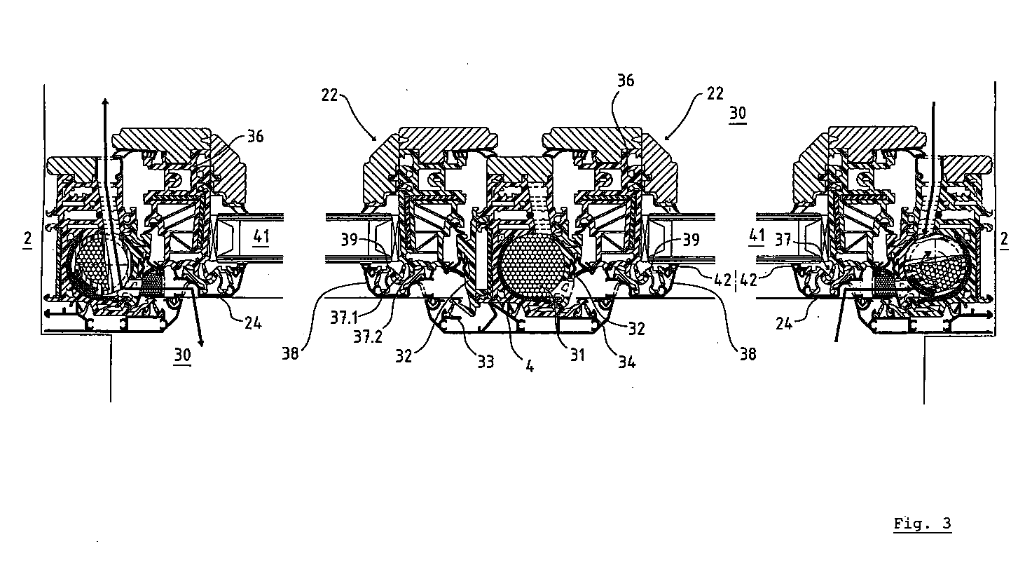

FIG. 3 a two-part window with a center post in horizontal section wherein again in the left part of the drawing the venting system is open and in the right part of the drawing the venting system is closed;

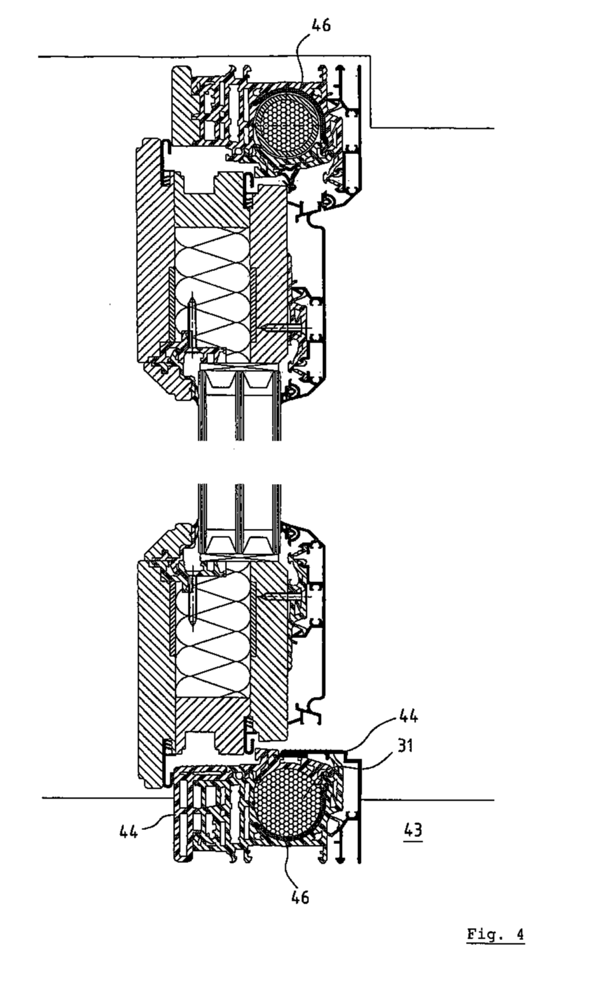

FIG. 4 a vertical section of an entry door with a casement frame according to the invention;

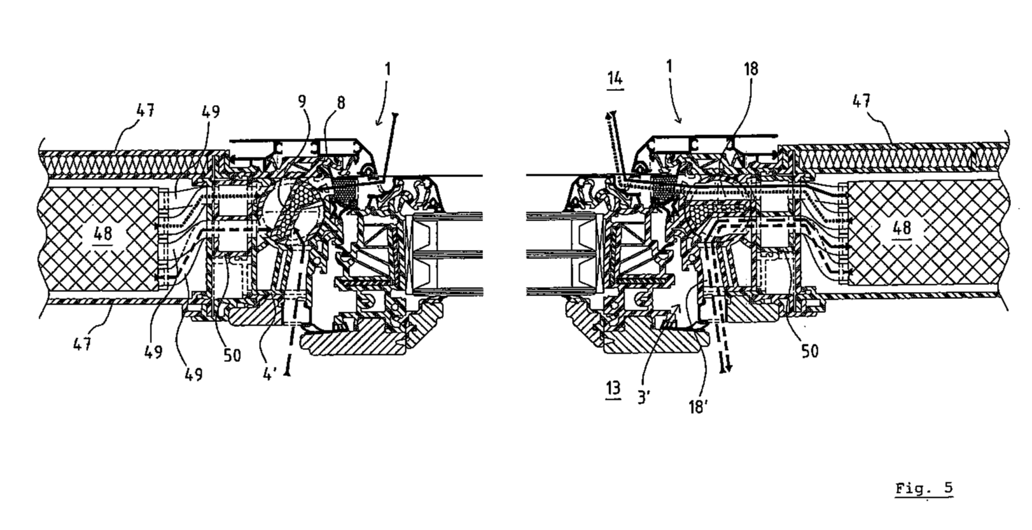

FIG. 5 a further embodiment of the casement frame according to the invention in horizontal section with a venting system and a heat exchanger;

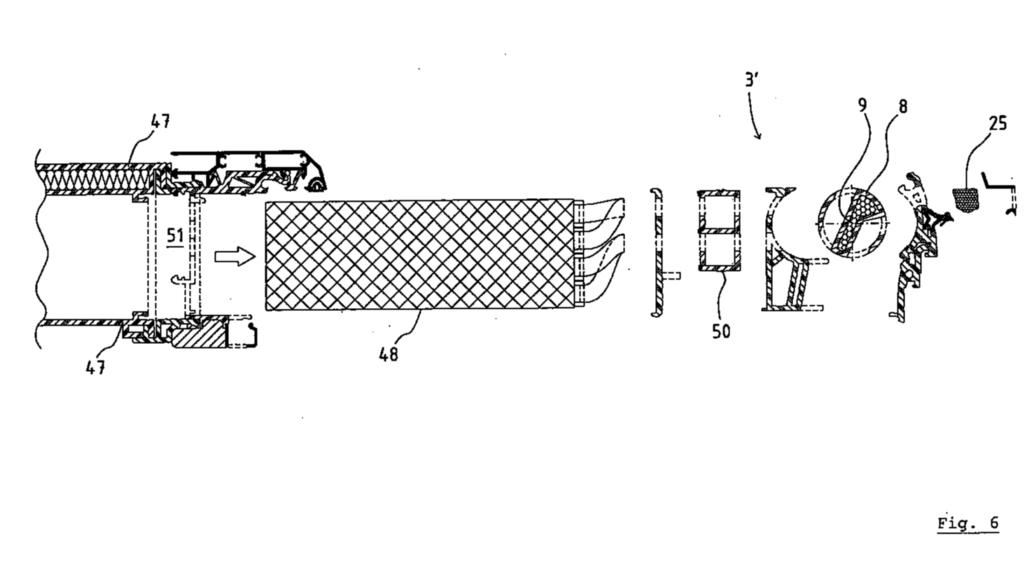

FIG. 6 an exploded view of a part of the article of FIG. 5;

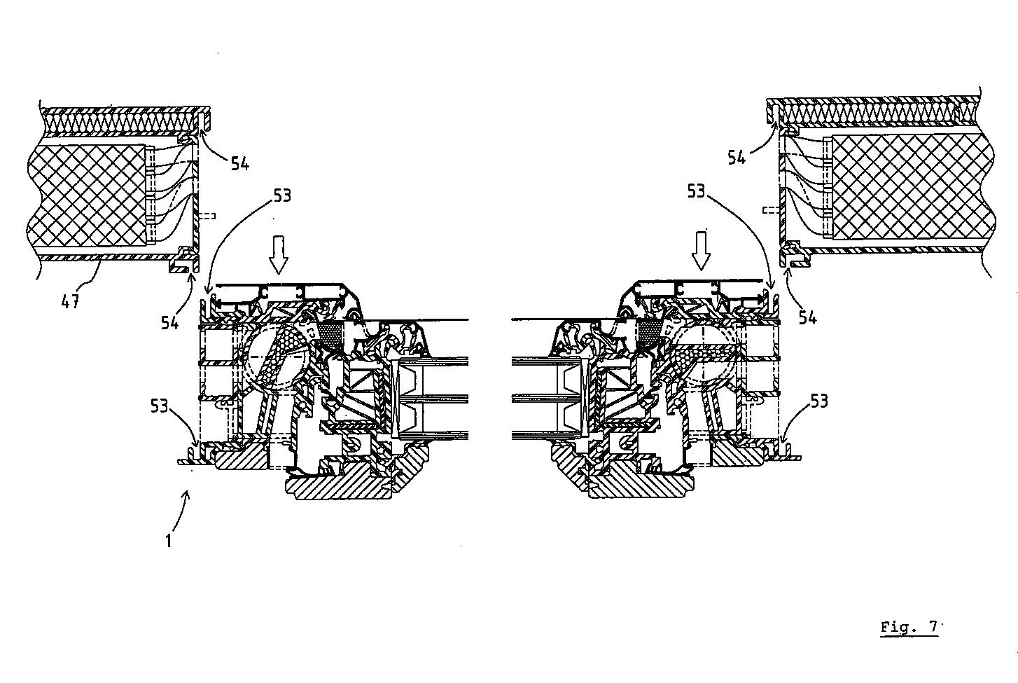

FIG. 7 a horizontal section of the article according to FIG. 5 in a dismounted position;

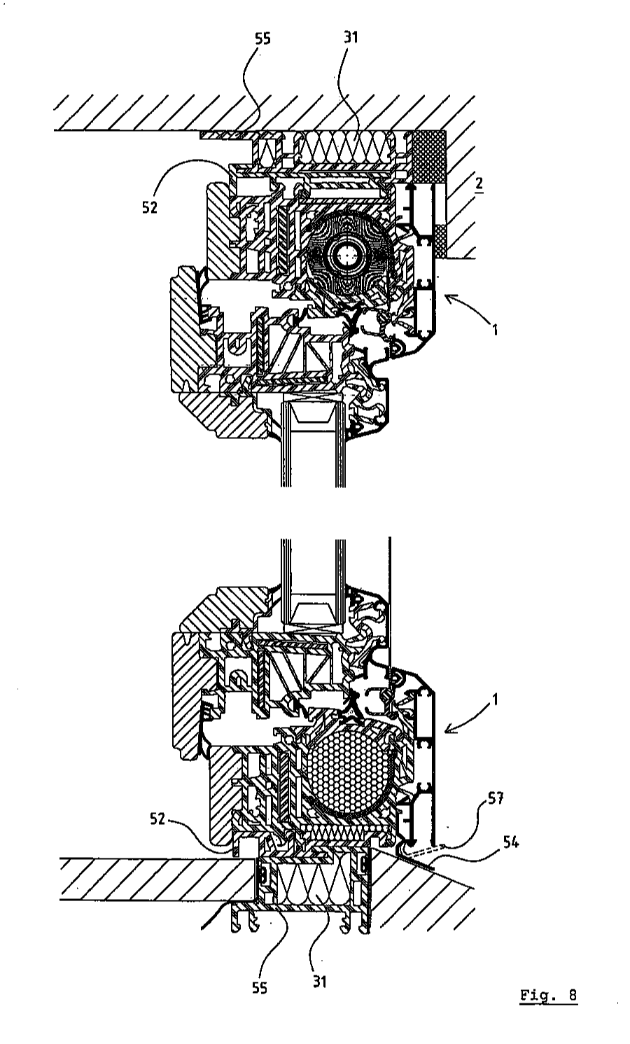

FIG. 8 the article according to FIG. 5 in vertical section;

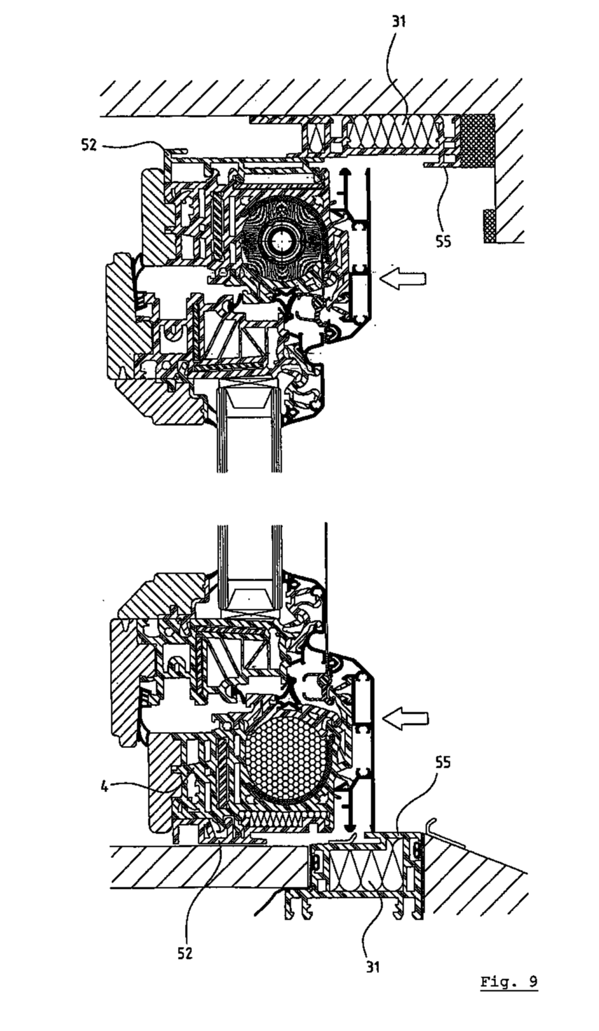

FIG. 9 the article of FIG. 8 in a dismounted situation;

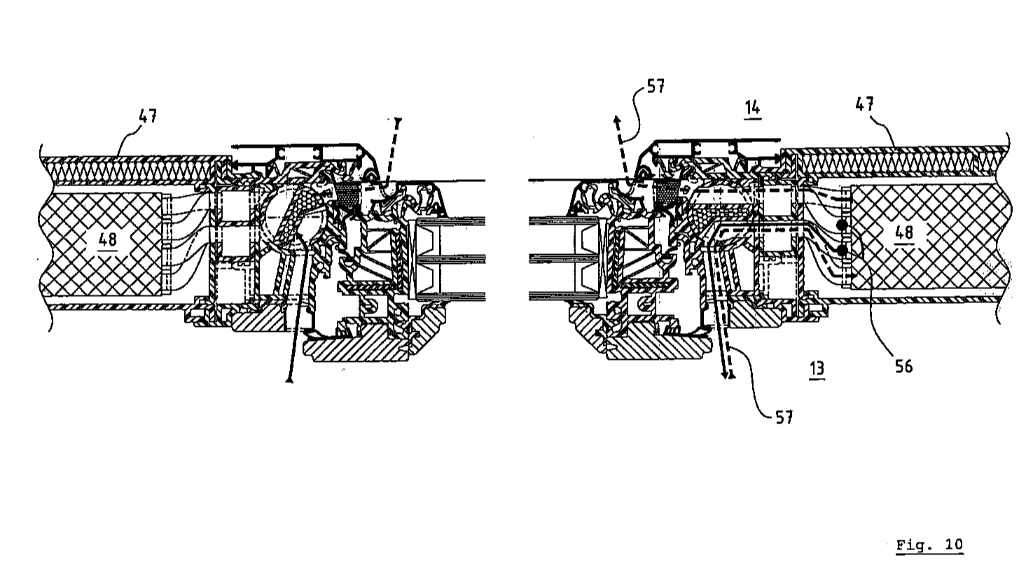

FIG. 10 a further embodiment of the invention with a venting system comprising a heat exchanger wherein the heat exchanger is modified as a result of the air-conditioning system conditioning the room.

The frame according to the invention, in this connection a casement frame 1 that is arranged in a wall 2, is essentially formed of a profiled frame section configured as a hollow profiled section 3. The hollow profiled section 3 has a basic profiled frame section configured as a basic hollow profiled section 4 that delimits at least partially, in addition to several insulation cavities 6, a cavity 7 for venting purposes. In this cavity 7 there is a venting pipe 9 that can be rotated about an axis 9 that corresponding to its longitudinal axis. The venting pipe 8 in cross-section is essentially divided into two chambers 11 and 12 of which the chamber 11 can provide a connection of the interior side 13 of the room to the exterior side 14 of the room, as illustrated to the left in FIG. 1. The black double arrow 16 symbolizes in this part of the Figure a connection between the interior side 13 and the exterior side 14.

In the right part of FIG. 1 the venting pipe 8 is rotated relative to the venting pipe 8 in the left part of the FIG. 1 as indicated by arrow 17. Instead of a rotation in a mathematically negative sense it is of course also possible to rotate in a mathematically positive sense. By rotating the venting pipe 8, an air supply or air removal area 18 facing the exterior side 14 is closed relative to an air supply or air removal area 18′ that is facing the interior side 13 by means of a seal that is embodied as a cavity seal 19 and is arranged at the exterior side of the venting pipe chamber 12. In this way, venting is interrupted and the interior and exterior sides 13 and 14 or the air supply and air removal areas 18, 18′ are separated from one another; this is illustrated by the two arrows 21.

Advantageously, the cavity 7 in cross-section is essentially round as can be seen in FIG. 1. When using also a round venting pipe 8 there are significant savings in space in comparison to other shape combinations. However, it is also conceivable to design the cavity 7 for example to be square in cross-section or to have a different shape and to introduce into it also a preferably round venting pipe 8 wherein the remaining area of the cavity 7 can then be filled with insulation material in order to further improve the insulation properties of the casement frame 1.

The basic hollow profiled section 4 of the casement frame according to the invention in this embodiment is configured as a platform profiled section to which various further profiled sections can be attached in many different ways. For a variable configuration of the connecting possibilities to a wing frame 22 as well as for a variable configuration of the casement frame 1 itself, open areas of the cavity 7 can be closed off by means of different profiled strips. The profiled strip 23 illustrated in FIG. 1 serves for or assists in the contacting of a wing frame 22 in the closed position of the casement frame 1 and the wing frame 22. As a result of the already mentioned configuration of the basic hollow profiled section 4 as a platform profiled section it is within the scope of the invention to also design the air supply and air removal areas 18, 18′ provided at least on two sides of the cavity 7 by attaching one or several additional profiled sections 24. The use of such additional profiled sections 24 leads to a further improved adaptability of the casement frame 1 according to the invention, for example, to different facade appearances.

In the embodiment illustrated to the left in FIG. 1, the air supply from the exterior side 14 is realized preferably through a preferably perforated additional profiled section 24, arranged on the wing frame 22 and embodied as a glazing securing strip, into the exterior air supply or air removal area 18 of the cavity 7, provided with a pollen filter 25, and further by corresponding longitudinal slots of the profiled strip 23 into the cavity 7; the profiled strip 23 is also referred to as casement frame cover strip. The venting passage extends farther through the open venting pipe 8 and furthermore through the basic hollow profiled section 4 opened by longitudinal slots as well as an additional profiled section 24 at the interior side that is clamped into projecting adapter stays 27 and is e.g. embodied as a perforated U-shaped aluminum profiled section that forms the cover of the air supply or air removal area 18′ toward the room side.

The sealing contact planes of the casement frame 1 are provided at the same time with connecting possibilities for various additional profiled sections, for example, possibilities for locking an additional profiled section in a fixed glazing casement frame or also the additional profiled section to be described in the following as a foot traffic protection when configuring the casement frame 1 in the lower area as a door sill. The additional profiled section 24 configured as a clamping aluminum section arranged on the interior side of the room (not the additional profiled section 24 that is configured as a glazing securing strip on the exterior side of the room) as well as the profiled strip 23 that serves as a casement frame cover strip can be removed easily and reinstalled easily for cleaning and maintenance purposes.

Advantageously, the cavity 7 as well as the venting pipe 8 arranged therein extend at least substantially across one side of the frame (FIG. 2). In FIG. 2, the basic hollow profiled section 4 is not illustrated so that the cavity 7 or the venting pipes 8 arranged on both sides of the opening 30 can be seen. The venting pipes 8 are provided with recesses 28 through which the air can pass in a venting situation.

Above the venting pipe 8 with its cutouts 28, a motor 29 is arranged in the cavity 7 on both sides of the frame, respectively. This motor 29 rotates as a function of control signals of its control unit (or of its optionally programmable and/or remote-controlled control electronics) the respective venting pipe 8 into the desired position. In this way, outside of the casement frame 1 no additional space is required and the entire venting system can be introduced into the casement frame 1 already before final assembly.

The casement frame 1 according to the invention that, as a result of the configuration of the basic hollow profiled section 4 as a platform profiled section with multifunctional capability, can be modified very flexibly, enables a variety of venting possibilities. In addition to simply opening the wing in the case of a casement frame/wing frame combination, a passive air exchange can be realized by motor-driven closable venting passages.

According to the invention, it is furthermore provided to operate the motor 29 by means of a remote control so that no additional wall areas are required for the control action. As needed, an energy supply can be realized by batteries of the motor 29 that must be exchanged from time to time or inductively charged or by means of electric connectors, not illustrated, to the power mains. The adaptation of the motor 29 to the already present cavities 7 of the hollow profiled section 3 leads to an excellent utilization of the existing spatial conditions within the casement frame 1. No special configurations of the hollow profiled section 3 must be provided for the arrangement of the motor 29.

According to FIG. 3, for a further configuration according to the invention a part of the cavity 7 that is not utilized for venting is filled with insulation material 31 (FIG. 3). The shape of the basic hollow profiled section 4 of the casement frame 1 filled with the insulation material corresponds to that of the basic hollow profiled section 4 on the sides of the wall opening 30, as described above. In addition, this central part of the casement frame 1 can be configured by means of different additional profiled sections as center post as a contact for the wing frame 22. Advantageously, the basic hollow profiled section 4 with its cavity 7 can thus be used because of its configuration as a platform profiled section also for more complex window shapes. In particular as a result of the attachment of a profiled section part 32 that, in the embodiment, has an identical stop for the wing frame 22 and as a result of the stay 33 that corresponds to a stay 34 of the basic hollow profiled section, the basic hollow profiled section 4 or the hollow profiled section 3 is turned into a center post with opposed contacting possibilities for two wing frames 22 in the area between the lateral parts of the casement frame 1

The basic profiled wing section 36 of the wing frame 22 has on its exterior side a double stay 37 as a locking and clamping profiled strip. When using an outer shell 38 of metal, an additional profiled locking section 39 of PVC is snapped into place as a thermal break onto this strip. The clip-on profiled section 39 can be configured also as a hollow cover shell and is clamped, when being pressed against the windowpane 41, on the upper pretensioned locking stay 37.1 of the basic profiled wing section 36, directly on the basic profiled section of the basic wing profiled section 36 at the bottom side, as well as on the bottom stay 37.2 of the basic profiled section 36. The PVC snap-on profiled section 39 that can be produced also of a different material can thus move freely in the pretensioned clamping profiled section of the basic profiled section 36 without becoming automatically detached. This is advantageous when the employed materials exhibit different thermal length expansions.

Advantageously, the snap-on profiled section can be removed without being destroyed in that the outer windowpane seal 42 is removed and the upper clamping stay 37.1 facing the glazing rebate is pressed out of the snap-on profiled section 39. The external shell 38 corresponds in this connection to the additional profiled section 24 embodied as a glazing securing strip that however also has openings for configuring (additionally) an air supply or air removal area 18. For such a configuration as a window it is understood that only the attachment strips located in the upper frame area of the window as well as in the lateral frame areas are to be provided with venting slots while the bottom frame area has no venting slots in order to prevent penetration of water.

The frame according to the invention in accordance with FIG. 4 is configured as an entry door sill adapter and has attached for this purpose in its lower area facing the ground 43 a foot traffic resistant profiled cover section 44. The lower cavity 7 is again filled with insulation material 31 while, depending on the requirements, the lateral areas of the combination of casement frame and wing frame forming the door are also provided with a venting system, for example. Additional inserts 46 made from fiberglass plastic material or other reinforcing materials that are not only used in this embodiment adjacent to the cavity 7 or in the casement frame 1 and can be used also in the embodiments of the above Figures, serve for additional stabilization of the supporting hollow profiled section 3.

In a further advantageous embodiment of the invention, a profiled heat exchanger section 47 comprising of a heat exchanger 48 is attached to the basic hollow profiled section 4′. For this purpose, the basic hollow profiled section 4′ is slightly modified in comparison to the cross-sectional shapes disclosed above. Because of the heat exchanger 48, the profiled heat exchanger section 47 extends possibly into the wall that is provided for this purpose with appropriate cutouts.

The heat exchanger 48 is advantageously configured to be controllable by means of the venting pipe 8 for which purpose the latter not only has a two-chamber configuration but, in order to ensure two air flows to the interior side and the exterior side of the room, respectively, has a complex multi-chamber division in particular along its longitudinal axis. The division can also be made dependent on whether the heat exchanger 48 is supposed to control the airflow together with a venting device or alone, for example. For connecting the heat exchanger 48, it is furthermore conceivable to convey the warm room air to be removed from the room interior 13 through venting openings into an upper area of the casement frame 1 to the heat exchanger 48 while the fresh air that is supplied from the exterior side 14 of the room is heated by the heat exchanger 48 and passes through the lower area into the interior 13. The division of the venting pipe 8 along its longitudinal axis 9 varies accordingly.

Instead of the heat exchanger 48 or in addition to it, it is also possible to mount a fan in the venting pipe 8 that then effects an active air exchange without impairing the visual appearance of the room.

Moreover, it is within the scope of the invention to exchange the heat exchanger 48 for an air conditioner. The latter can be connected through the venting pipe 8 to the air supply/air removal areas 18, 18′ and supply the room with cold or warm air. By means of a corresponding configuration of the venting pipe 8 and the surrounding profiled sections it is also possible to connect the venting system to a central air-conditioning system in order to ensure an optimal venting management and also energy management of the room in connection with other rooms.

In the embodiment of the invention according to FIG. 5 the heat exchanger 48 can be controlled by the venting pipe 8. The connectors 49 of the heat exchanger 48 are connected by a profiled adapter section 52 to the chambers of the venting pipe 8 and can provide a connection of the interior 13 to the exterior 14 through the heat exchanger 48 in the right angular position of the venting pipe 8 of FIG. 5 or interrupt the connection when in the adjustment position illustrated in the left half of Figure. The four connectors 49 of the heat exchanger 48 are connected by venting passages of the venting pipe 8 and the air supply and air removal areas 18, 18′ to the interior or exterior 13, 14.

For servicing the heat exchanger 48 it is possible to design the hollow profiled section of the casement frame 1 according to the invention of several detachably connected parts (FIG. 6). The individual parts of the hollow profiled section 3′ are designed such that when the window is open the inwardly located profiled sections can be removed one after another from the frame 1 that is still connected to the wall. Upon complete removal of the inner individual parts an access hole 51 is provided through which the heat exchanger 48 can be removed from the profiled section 47 for servicing purposes.

Particularly advantageous is the configuration of a reversing frame that simplifies mounting of the casement frame 1 according to the invention and also its removal significantly (FIG. 7). This version of the frame can be utilized also without the venting system. By attaching a profiled coupling section 52 on the hollow profiled section 3 or on the basic hollow profiled section 4 of the casement frame 1, the frame according to the invention has engagement areas 53 for a complementary profiled section of the wall into which the reversing frame can be inserted and from which the frame can be pulled out in a dismounting situation and which in this embodiment corresponds to the profiled heat exchanger section 47. Instead of a profiled heat exchanger section 47 it is also conceivable to provide profiled sections that have only the complementary engagement areas 54.

By means of this configuration of the frame 3 its handling is significantly simplified. The frame 3 can be dismounted from adjoining wall sections or window sills without causing any damage.

In addition to the horizontal section the article of the present invention embodied as a reversing frame is shown in FIG. 8 in vertical section. The profiled locking section 54 is provided with a predetermined breaking point so that, after buckling into the position identified at 57 and after removing additional fastening means, the complete frame with the exception of the complementary profiled coupling sections 55 can be moved into the removal position illustrated in FIG. 9.

It is also within the scope of the invention to connect in addition to a heat exchanger 48 an air-conditioning device to the room which, for example, is mounted in a profiled section correlated with the casement frame or is attachable separate from the casement frame. The supply of air of a certain temperature into the interior 13 causes an overpressure situation. In case of a normal function of the heat exchanger 48, this entails the risk of penetration of external air at a temperature that is different than the desired temperature. It is therefore provided according to the invention to close an air passage of the heat exchanger 48 with check valves 56 wherein in addition the rotational direction of a fan wheel belonging to the heat exchanger is changed (FIG. 10). The thus resulting removal of interior air of the room through the remaining open passage of the heat exchanger is illustrated by arrow 57.

What is claimed is:

1.-36. (canceled)

37. Frame for use in wall openings of a rooms, the frame comprising:
a profiled frame section comprising at least one basic profiled frame section and a cavity connectable for venting to at least one of an interior side and an exterior side of the room;
a venting system comprising a venting element movably arranged in the cavity and having a main axis that extends parallel to a longitudinal axis of the profiled frame section, wherein the venting element has a shape that defines an air passage in the cavity;
wherein the basic profiled frame section at least partially defines the cavity.

38. Frame according to claim 37, further comprising profiled strips for further modifying the profiled frame section, wherein the cavity is partially open and is coverable with the profiled strips.

39. Frame according to claim 37, wherein the cavity has a round cross-section.

40. Frame according to claim 37, wherein the cavity extends at least across substantially one side of the frame.

41. Frame according to claim 37, wherein the profiled frame section has air supply and air removal areas arranged on at least two sides of the cavity.

42. Frame according to claim 37, wherein the venting element has at least one venting element chamber that creates a venting connection between the air supply and air removal areas by moving the venting element into a venting position.

43. Frame according to claim 42, wherein the venting element has a cavity seal that separates the venting connection when moving the venting element into a closed position.

44. Frame according to claim 42, wherein the air supply and air removal areas have at least one air filter.

45. Frame according to claim 42, further comprising at least one additional profiled section for limiting the air supply and air removal areas.

46. Frame according to claim 45, further comprising a wing frame wherein the additional profiled section is part of the wing frame.

47. Frame according to claim 37, wherein the venting system has a motor and a control unit, wherein the control actuates the motor to move the venting element.

48. Frame according to claim 47, wherein the motor is arranged in the cavity.

49. Frame according to claim 48, wherein the venting system has at least one sensor and the control unit controls venting of the room as a function of control data received from the at least one sensor.

50. Frame according to claim 42, wherein one of the at least one venting element chamber is filled with insulation material.

51. Frame according to claim 37, wherein the venting system comprises a heat exchanger.

52. Frame according to claim 51 wherein the heat exchanger is arranged at least partially in a wall of the room.

53. Frame according to claim 51 wherein the heat exchanger is arranged in a profiled heat exchanger section attached to the profiled frame section.

54. Frame according to claim 51, wherein the heat exchanger is connectable for venting by the venting element to the interior and exterior sides of the room.

55. Frame according to claim 51 wherein the venting element has at least one venting element chamber that creates a venting connection between the air supply and air removal areas by moving the venting element into a venting position, wherein the heat exchanger is connected independent of the venting element to the air supply and air removal areas.

56. Frame according to claim 37, wherein an area of the cavity that does not comprise parts of the venting system is sealed with insulation material.

57. Frame according to claim 37, wherein the venting element is a rotatable venting pipe.

58. Frame according to claim 37, wherein the venting element is a profiled chamber element that is longitudinally slidable in a direction of a main axis of the venting element.

59. Frame according to claim 37, wherein the basic profiled frame section is a basic hollow profiled section.

60. Frame according to claim 37, wherein the profiled frame section is a hollow profiled section.

61. Frame according to claim 37, further comprising a reversing profiled section for detachably securing the frame.

62. Frame according to claim 61, wherein the reversing profiled section has at least a first part and a second part, wherein the first part is securable to a wall of the room and the second part is correlated with the frame, wherein the first and second parts each have at least one fastening area for connecting the frame to the wall.

63. Frame according to claim 61, wherein the second part correlated with the frame is a part of the profiled frame section.

64. Frame according to claim 37, wherein the venting system comprises an air-conditioning device.

65. Frame according to claim 64, wherein the air-conditioning device is arranged in a cavity provided in a wall of the room.

66. A window comprising a frame according to claim 37.
